(19) United States
(12) Patent Application Publication
(10) Pub. No.: US 2009/0156050 A1
(43) Pub. Date: Jun. 18, 2009

(54) PORTABLE ELECTRONIC APPARATUS, POWER DETECTION JACK AND POWER DETECTION METHOD

(76) Inventors: Yu-Cheng SHEN, Taipei (TW); Yi-Wen Chiu, Taipei (TW); Min-Hua Hsu, Taipei (TW)

Correspondence Address: Muncy, Geissler, Olds & Lowe, PLLC, P.O. BOX 1364, FAIRFAX, VA, 22038-1364, US

(21) Appl. No.: 12/207,006

(22) Filed: Sep. 9, 2008

(30) Foreign Application Priority Data
Dec. 14, 2007 (TW) 096147967

(51) Int. Cl. H01R 3/00

(52) U.S. Cl. 439/488

(57) ABSTRACT

A power detection jack can be connected with a plurality of power output jacks respectively to receive different power levels. Each of the power output jacks has a first insulation element, and the lengths of the first insulation elements are different from each other. The power detection jack includes a first electrode, a second electrode and a power detection element. The first electrode is disposed inside the power detection jack. The second electrode is disposed outside the power detection jack. The power detection element is disposed between the first electrode and the second electrode. When the power detection jack is connected with one of the power output jacks, the power level provided by the power output jack is determined according to a connection state of the power detection element and the first insulation element.

### CROSS REFERENCE TO RELATED APPLICATIONS

This Non-provisional application claims priority under 35 U.S.C. §119(a) on Patent Application No(s). 096147967 filed in Taiwan, Republic of China on Dec. 14, 2007, the entire contents of which are hereby incorporated by reference.

### BACKGROUND OF THE INVENTION

1. Field of Invention

The invention relates to a portable electronic apparatus and, in particular, to the power detection jack and power detection method of a portable electronic apparatus.

2. Related Art

With the progress of technology, more and more novel portable electronic apparatuses are disclosed. The novel portable electronic apparatuses, such as the notebook computer, PDA (Personal Digital Assistant), mobile phone and mobile internet device, can make to user more convenient. However, the portable electronic apparatuses still have some application limitations due to the power sources thereof.

The conventional portable electronic apparatus usually has a power jack for receiving the electric power, which can be used for the operation power of the portable electronic apparatus or for charging the battery of the portable electronic apparatus. In order to speed the charging time of the battery, the adaptor with the fast charging function is invented. However, the power levels of the general adaptor and the adaptor with the fast charging function are different. For example, the currents, voltages or powers outputted from the general adaptor and the adaptor with the fast charging function are different. If the portable electronic apparatus does not have the design in accordance with the fast charging function, the components thereof may be overheated or burnt out due to the over loadings when connecting to the adaptor with the fast charging function.

Therefore, it is an important subject to provide a portable electronic apparatus, a power detection jack and a power detection method that can identify the received power level and then perform the proper action, thereby preventing from damaging the product and thus improving the product utility.

### SUMMARY OF THE INVENTION

In view of the foregoing subject, an object of the invention is to provide a portable electronic apparatus, a power detection jack and a power detection method that can identify the received power level and then perform the proper action, thereby preventing from damaging the product and thus improving the product utility.

To achieve the above object, the invention discloses a power detection jack, which is capable of connecting to a plurality of power output jacks respectively to receive different power levels. Each power output jack has a first insulation element, and the lengths of the first insulation elements are different from each other. The power detection jack includes a first electrode, a second electrode and a power detection element. The first electrode is disposed inside the power detection jack. The second electrode is disposed outside the power detection jack. The power detection element is disposed between the first electrode and the second electrode. When the power detection jack is connected with one of the power output jacks, the power level provided by the power output jack is determined according to a connection state of the power detection element and the first insulation element.

To achieve the above object, the invention also discloses a portable electronic apparatus, which is capable of connecting to a plurality of power output jacks respectively to receive different power levels. Each power output jack has a first insulation element, and the lengths of the first insulation elements are different from each other. The portable electronic apparatus includes a host and a power detection jack. The power detection jack is disposed on the host and includes a first electrode, a second electrode and a power detection element. The first electrode is disposed inside the power detection jack. The second electrode is disposed outside the power detection jack. The power detection element is disposed between the first electrode and the second electrode. When the power detection jack is connected with one of the power output jacks, the power level provided by the power output jack is determined according to a connection state of the power detection element and the first insulation element.

To achieve the above object, the invention further discloses a power detection method including the steps of providing a power detection jack to connect with a power output jack, and determining a power level provided by the power output jack according to a connection state of a power detection element of the power detection jack and a first insulation element of the power output jack.

As mentioned above, the portable electronic apparatus, power detection jack and power detection method of the invention can determine the power level provided by the power output jack according to the connection state of the power detection element and the first insulation element so as to perform the proper action. Accordingly, the portable electronic apparatus of the invention can identify the received power level and then execute the suitable response to the inputted power, thereby preventing from damaging the product and thus improving the product utility.

### BRIEF DESCRIPTION OF THE DRAWINGS

The invention will become more fully understood from the detailed description and accompanying drawings, which are given for illustration only, and thus are not limitative of the present invention, and wherein:

FIGS. 1A and 1B are schematic diagrams of a power output jack and a power detection jack according to a preferred embodiment of the invention;

FIGS. 2A and 2B are schematic diagrams of another power output jack and the power detection jack according to the preferred embodiment of the invention;

FIG. 3 is a schematic diagram showing another aspect of the power detection jack according to the preferred embodiment of the invention;

FIG. 4 is a flow chart showing a power detection method according to the preferred embodiment of the invention; and

FIG. 5 is a schematic diagram showing a portable electronic apparatus according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

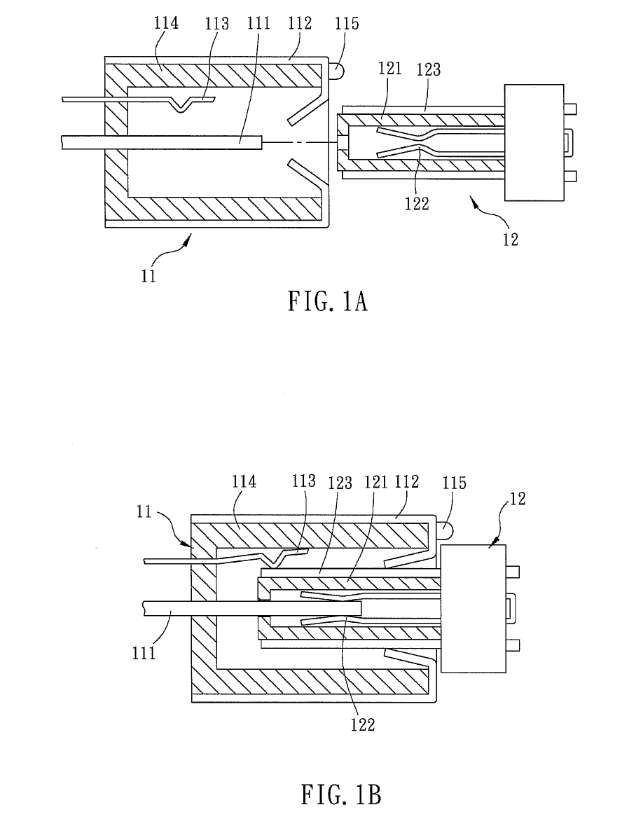

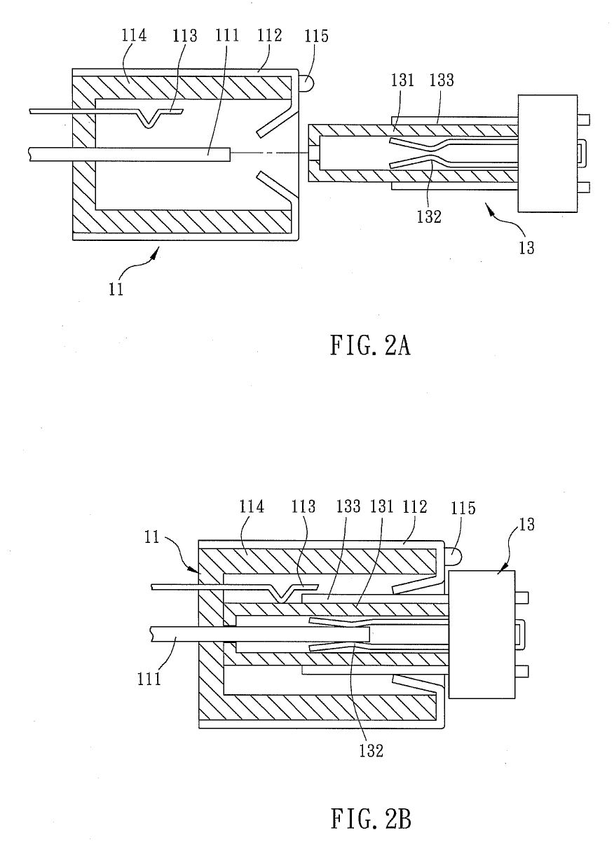

With reference to FIGS. 1A and 2A, a power detection jack 11 according to a preferred embodiment of the invention can be connected to a plurality of power output jacks for receiving different power levels. The power detection jack 11 can determine the received power level and then perform the proper action. Thus, the inputted power can be used to drive the portable electronic apparatus or charge the battery of the portable electronic apparatus without affecting the internal circuits thereof. The power output jacks can be different. For example, each of the power output jacks can have a first insulation element, and the lengths of the power output jacks are different each other. FIG. 1A shows one aspect of the power output jack 12, and FIG. 2A shows another aspect of the power output jack 13. In the embodiment, the lengths of the first insulation element 121 in the power output jack 12 and the second insulation element 131 in the power output jack 13 are different. The first insulation element 121 is shorter than the first insulation element 131. To be noted, the descriptions of the above-mentioned first insulation elements 121 and 131 are for illustrations only and are not to limit the scope of the invention.

As shown in FIG. 1A, the power detection jack 11 includes a first electrode 111, a second electrode 112 and a power detection element 113. The first electrode 111 is disposed inside the power detection jack 11, and the second electrode 112 is disposed outside the power detection jack 11. The power detection element 113 is disposed between the first electrode 111 and the second electrode 112.

Either one of the first electrode 111 and the second electrode 112 of the power detection jack 11 can be a grounding electrode, and a voltage difference is provide between the first electrode 111 and the second electrode 112. In the embodiment, the second electrode 112 is a grounding electrode. The power detection element 113 can be an elastic metal for detecting different kinds of power output jacks. Then, the power detection element 113 can determine the type of the power output jack according to the connection state, such as an electro-conductive state. In addition, the power detection jack 11 may further include a second insulation element 114 disposed between the first electrode 111 and the second electrode 112 for insulating the first electrode 111 and the second electrode 112.

Referring to FIGS. 1A and 2A, the power output jack 12 (13) further includes a third electrode 122 (132) and a fourth electrode 123 (133). The third electrode 122 (132) is disposed in the power output jack 12 (13), and the fourth electrode 123 (133) is disposed outside the power output jack 12 (13). The third electrode 122 (132) and the fourth electrode 123 (133) are insulated by a first insulation element 121 (131). In the embodiment, the fourth electrode 123 (133) is a grounding electrode for example.

When the power detection jack 11 is connected with any one of the power output jacks 12 and 13, the power detection jack 11 can determine the power level provided by the power output jack 12 or 13 according to the connection state of the power detection element 113 and the first insulation element 121 or 131. The determinations of the power levels will be described hereinbelow with reference to FIG. 1B and FIG. 2B, respectively.

As shown in FIG. 1B, when the power detection jack 11 is connected with the power output jack 12, the power detection jack 11 can receive the power level provided by the power output jack 12. In this case, the first electrode 111 is connected with the third electrode 122, and the second electrode 112 is connected with the fourth electrode 123. Thus, the power source is applied from the power output jack 12 to the power detection jack 11. Since the first insulation element 121 of the power output jack 12 is shorter, the power detection element 113 can contact with the fourth electrode 123, but not contact with the first insulation element 121. Herein, the fourth electrode 123 is a grounding electrode, so the power detection element 113 is grounded.

As shown in FIG. 2B, when the power detection jack 11 is connected with the power output jack 13, the power detection jack 11 can receive the power level provided by the power output jack 13. In this case, the first electrode 111 is connected with the third electrode 132, and the second electrode 112 is connected with the fourth electrode 133. Thus, the power source is applied from the power output jack 13 to the power detection jack 11. Since the first insulation element 131 of the power output jack 13 is longer, the power detection element 113 can contact with the first insulation element 131, but not contact with the fourth electrode 133. Herein, the first insulation element 131 is insulated, so the power detection element 113 is floating.

As mentioned above, the power output jacks 12 and 13 have different power levels, such as different currents, voltages or powers. The received power level can be determined according to the connection state of the power detection element 113 and the first insulation element 121 or 131. In addition, the power detection jack 11 can further include an indicating lamp 115 disposed on the power detection jack 11 for showing the connection state. For example, when the power detection jack 11 is connected with the power output jack 12, the indicating lamp 115 is turned on. Alternatively, when the power detection jack 11 is connected with the power output jack 13, the indicating lamp 115 is turned off.

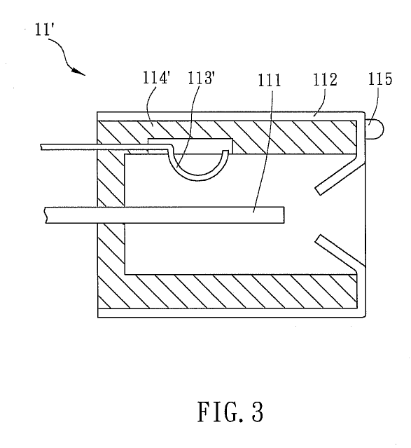

Moreover, the position of the power detection element 113 can be changed. The main rule is to dispose the power detection element 113 corresponding to the first insulation element 121 or 131 of the power output jack 12 or 13. In the embodiment, the power detection element 113 passes through the second insulation element 114. Alternatively, as shown in FIG. 3, the power detection element 113′ is embedded on the second insulation element 114′.

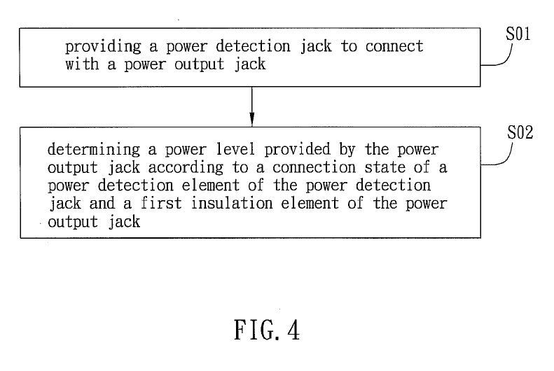

With reference to FIG. 4, a power detection method according to the preferred embodiment of the invention includes the following steps S01 to S02. The step S01 is to provide a power detection jack to connect with a power output jack. The step S02 is to determine a power level provided by the power output jack according to a connection state of a power detection element of the power detection jack and a first insulation element of the power output jack. The power detection method is illustrated in the above-mentioned embodiment, so the detailed description thereof will be omitted.

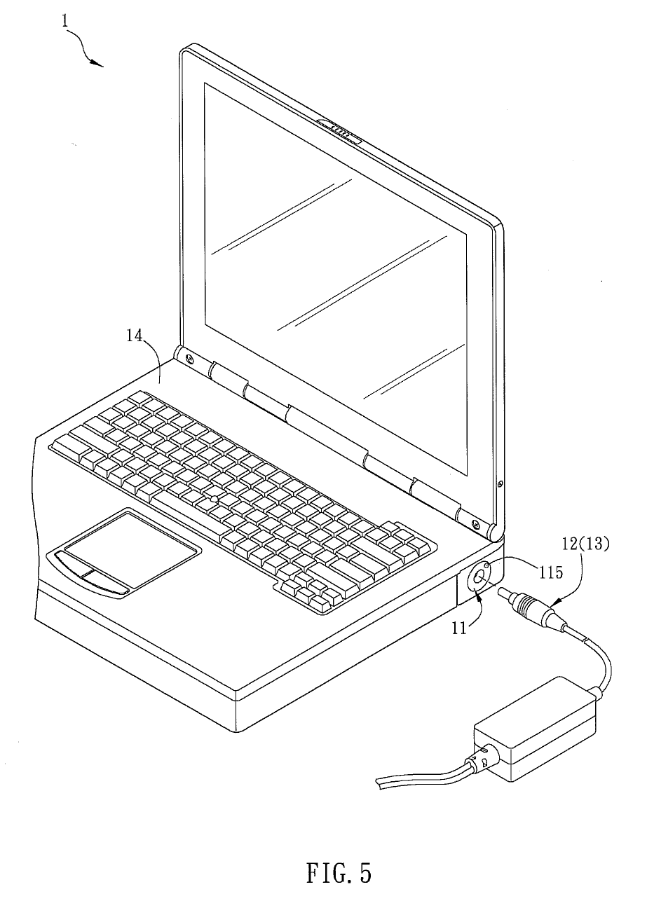

Referring to FIG. 5, a portable electronic apparatus 1 according to the preferred embodiment of the invention is capable of connecting to a plurality of power output jacks respectively to receive different power levels. Each of the power output jacks has a first insulation element, and the lengths of the first insulation elements are different from each other. The power output jack is, for example, the previously mentioned power output jack 12 or 13. The portable electronic apparatus 1 includes a host 14 and a power detection jack 11. The portable electronic apparatus 1 can be, for example but not limited to, a notebook computer, a mobile phone or a personal digital assistant (PDA). The portable electronic apparatus 1 can be understood in view of the above-mentioned power detection jack 11 and the power detection method, so the detailed description thereof will be omitted.

To sum up, the portable electronic apparatus, power detection jack and power detection method of the invention can determine the power level provided by the power output jack according to the connection state of the power detection element and the first insulation element so as to perform the proper action. Accordingly, the portable electronic apparatus of the invention can identify the received power level and then execute the suitable response to the inputted power, thereby preventing from damaging the product and thus improving the product utility.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A power detection jack capable of selectively connecting to one of a plurality of power output jacks respectively to receive different power levels, each of the power output jacks having a first insulation element, and lengths of the first insulation elements being different from each other, the power detection jack comprising:
a first electrode disposed inside the power detection jack;
a second electrode disposed outside the power detection jack; and
a power detection element disposed between the first electrode and the second electrode, wherein when the power detection jack is connected with one of the power output jacks, the power level provided by the power output jack is determined according to a connection state of the power detection element and the first insulation element.

2. The power detection jack according to claim 1, wherein the connection state indicates that the power detection element is connected with the first insulation element or the power detection element is connected with a third electrode of the power output jack.

3. The power detection jack according to claim 1, wherein the power detection element is an elastic metal.

4. The power detection jack according to claim 1, further comprising:
a second insulation element disposed between the first electrode and the second electrode.

5. The power detection jack according to claim 4, wherein the power detection element passes through the second insulation element.

6. The power detection jack according to claim 4, wherein the power detection element is embedded on the second insulation element.

7. The power detection jack according to claim 1, further comprising:
an indicating lamp disposed on the power detection jack for showing the connection state.

8. The power detection jack according to claim 1, wherein the first electrode is a grounding electrode.

9. The power detection jack according to claim 1, wherein the second electrode is a grounding electrode.

10. A portable electronic apparatus capable of selectively connecting to one of a plurality of power output jacks respectively to receive different power levels, each of the power output jacks having a first insulation element, and lengths of the first insulation elements being different from each other, the portable electronic apparatus comprising:
a host; and
a power detection jack disposed on the host and comprising:
a first electrode disposed inside the power detection jack,
a second electrode disposed outside the power detection jack, and
a power detection element disposed between the first electrode and the second electrode, wherein when the power detection jack is connected with one of the power output jacks, the power level provided by the power output jack is determined according to a connection state of the power detection element and the first insulation element.

11. The portable electronic apparatus according to claim 10, wherein the connection state indicates that the power detection element is connected with the first insulation element or the power detection element is connected with a third electrode of the power output jack.

12. The portable electronic apparatus according to claim 10, wherein the power detection element is an elastic metal.

13. The portable electronic apparatus according to claim 10, wherein the power detection jack further comprises a second insulation element disposed between the first electrode and the second electrode.

14. The portable electronic apparatus according to claim 13, wherein the power detection element passes through the second insulation element.

15. The portable electronic apparatus according to claim 13, wherein the power detection element is embedded on the second insulation element.

16. The portable electronic apparatus according to claim 10, wherein the power detection jack further comprises an indicating lamp disposed on the power detection jack for showing the connection state.

17. The portable electronic apparatus according to claim 10, wherein the first electrode is a grounding electrode.

18. The portable electronic apparatus according to claim 10, wherein the second electrode is a grounding electrode.

19. A power detection method, comprising steps of:
providing a power detection jack to connect with a power output jack; and
determining a power level provided by the power output jack according to a connection state of a power detection element of the power detection jack and a first insulation element of the power output jack.

20. The power detection method according to claim 19, wherein the connection state indicates that the power detection element is connected with the first insulation element or the power detection element is connected with a third electrode of the power output jack.
